(19) United States
(12) Patent Application Publication
(10) Pub. No.: US 2019/0131035 A1
(43) Pub. Date: May 2, 2019

(54) Charging Cable For Transmitting Electrical Energy, Charging Plug and Charging Station For Discharging Electrical Energy To a Recipient of Electrical Energy

(71) Applicant: PHOENIX CONTACT E-Mobility GmbH, Schieder-Schwalenberg (DE)

(72) Inventors: Thomas FÜHRER, Blomberg (DE); Robert BABEZKI, Steinheim (DE)

(21) Appl. No.: 16/093,326

(22) PCT Filed: Apr. 6, 2017
(86) PCT No.: PCT/EP2017/058211

§ 371 Date: Oct. 12, 2018

(30) Foreign Application Priority Data
Apr. 14, 2016 (DE) 10 2016 206 266.2

(51) Int. Cl. H01B 7/42; H02J 7/00

(52) U.S. Cl. CPC H01B 7/421; B60L 11/1818; H01B 7/423; H02J 7/0045

(57) ABSTRACT

The present invention discloses a charging cable (1) for transmitting electrical energy, having a cable sheath (2) and at least one electric conductor cable (3) arranged within the cable sheath (2), wherein the charging cable (1) is characterized in that at least one cavity (10) within the charging cable (1), between the cable sheath (2) and the electric conductor cable (3), is filled with a heat conduction medium (11), such that the heat conduction medium (11) is in direct contact with the electric conductor cable (3).

The present invention relates to a charging cable for transmitting electrical energy, which is specifically employed for the transmission of electrical energy during the charging of an electric vehicle. The present invention further relates to a charging plug for connection to a corresponding connecting device, and for the transmission of electrical energy. The present invention further relates to a charging station for discharging electrical energy to a recipient of electrical energy.

From the prior art, charging cables for the transmission of electrical energy are known, which comprise at least one electric conductor cable, enclosed in a cable sheath. During the transmission of electric currents via the electric conductor cable, the latter is subject to heat-up as a result of ohmic losses within the electric conductor cable. Heat-up of the electric conductor cable in turn increases the ohmic resistance of said electric conductor cable, such that heat-up of the electric conductor cable proceeds in an accelerated manner.

In charging cables known from the prior art, the electric conductor cables, together with any further structures present, such as filler cords of a fibrous material, are configured with a circular cross-section, such that the electric conductor cables assume only a single line of contact with other structures present in the charging cable. Accordingly, the transmission of heat from the electric conductor cable to other structures present in the charging cable is not highly efficient.

For the reduction of heat generated, the ohmic resistance of the electric conductor cable must be reduced. To this end, it is known for the conductor cross-sections of electric conductor cables to be increased. For reasons of handling, however, this method is subject to limitations, as a corresponding charging cable, for the transmission of charging currents of 350 A at voltages up to 1,000 V, would be of such size and weight that the use of a charging plug, in which a corresponding charging cable terminates, would only be possible with difficulty, as a corresponding charging cable would be of an excessively high weight.

From the prior art, charging plugs for electrically-propelled vehicles are known, which are designed for connection to a corresponding connecting device, configured in the form of a bush. Reference may be made in this regard to the charging plug disclosed in DE 10 2012 105 774 B3. In the charging plug, power contacts are arranged, each of which comprises a first contact region and a second contact region. The first contact region is configured as a contact bush, and is suitable for galvanic connection with a contact pin, wherein the contact pin is galvanically connected to a recipient of electrical energy, for example an accumulator of a vehicle. The second contact region of the power contact is configured for galvanic connection to an electrical energy source, for example a charging station or, in general, to an electric power supply grid. To this end, the second contact region is permanently attached to a charging cable.

As a result of a charging current flowing in the charging cable, said charging cable is inevitably subject to heat-up associated with current thermal losses. However, heat-up of the charging cable is restricted by a limiting temperature increase. Thus, for example, according to IEC standard 62196-3, the limiting temperature increase is restricted to 50° K., thereby resulting in the limitation of the maximum charging current.

For the charging of an accumulator, conversely, higher charging currents of 350 A or more are required over limited time periods, in order to charge an accumulator within the requisite short time. In turn, this results in a short-term heat-up of the charging cable, in excess of the limiting temperature increase. As mentioned above, the conductor cross-section of the charging cable cannot be increased at will, as this will impede the handling of the charging plug which is connected to the charging cable, or even render said handling impossible for a single person.

The object of the present invention is the disclosure of a charging cable which permits increased charging currents with limited heat-up, and consequently shows improved current-carrying capacity.

This object is fulfilled by a charging cable having the characteristics of claim 1. Advantageous forms of embodiment are described in the claims which are dependent upon claim 1.

A further object of the present invention is the disclosure of a charging plug, by means of which increased charging currents can be transmitted, with no inordinate heat-up of said charging plug.

This object is fulfilled by a charging plug having the characteristics of claim 9.

Finally, the object of the present invention is the disclosure of a charging station for the discharge of electrical energy to a recipient of electrical energy, by means of which increased peak charging currents can be transmitted. This object is fulfilled by a charging station having the characteristics of claim 10.

More specifically, the object of the present invention is fulfilled by a charging cable for transmitting electrical energy, having a cable sheath and at least one electric conductor cable arranged within the cable sheath, wherein at least one cavity within the charging cable, between the cable sheath and the electric conductor cable, is filled with a heat conduction medium, such that the heat conduction medium is in direct contact with the electric conductor cable.

By means of the direct and immediate contact of the heat conduction medium with the electric conductor cable, heat generated in the electric conductor cable by ohmic losses is transmitted more effectively to the remainder of the charging cable. Consequently, the electric conductor cable assumes a lower temperature, such that higher charging currents can be transmitted by means of the electric conductor cable, with no inordinate heat-up of the electric conductor cable and the charging cable itself. Consequently, by means of the charging cable according to the invention, it is possible to transmit higher charging currents, without increasing the conductor cross-section/conductor cross-sections of the electric conductor cable/electric conductor cables. As a result, the ease of handling of the charging cable and, for example, of a charging plug which is coupled to the charging cable, is not impaired, notwithstanding the fact that higher charging currents can be transmitted by means of the charging cable. Moreover, any inordinate heat-up of the electric conductor cable/electric conductor cables is prevented.

The electric conductor cable is enclosed in an insulating sheath, such that the clear space between the cable sheath and the insulating sheath of the electric conductor cable is filled with the heat conduction medium. The heat conduction medium is therefore in direct and immediate contact with the insulating sheath of the electric conductor cable.

Naturally, the charging cable according to the invention can also comprise two or more electric conductor cables, wherein the cavities between the cable sheath and the respective electric conductor cables are then filled with the heat conduction medium.

The heat conduction medium does not counteract the bending of the charging cable, such that the effective manageability of the charging cable is maintained.

The charging cable is specifically configured for coupling to a charging plug, for the charging of an electric vehicle.

The heat conduction medium can preferably be configured as a gel, or as a heat conduction gel. For example, the heat conduction gel can be configured as a water-based gel and/or as a colloid system. The water-based gel and/or colloid system can incorporate methyl cellulose and/or alginate.

Moreover, the heat conduction medium can preferably be configured as a heat conduction fluid.

The heat conduction medium according to the present invention is not to be understood as a gas, and specifically not as air or atmospheric air.

Preferably, the charging cable comprises at least one cooling line, which is arranged within the cable sheath and can accommodate a flux of coolant fluid.

By the provision of a cooling line which can accommodate a flux of coolant fluid, the cooling of the charging cable is further improved. Heat generated in the electric conductor cable by ohmic losses is transmitted via the heat conduction medium to the cooling line, and thus to the flux of coolant fluid within the cooling line, such that the temperature of the entire charging cable, and specifically the temperature of the electric conductor cable/electric conductor cables is/are reduced in a particularly effective manner. Consequently, using a correspondingly configured charging cable, even higher charging currents can be transmitted, without the necessity for the enlargement of the cross-sections of electric conductor cables. Ease of handling of the charging cable, and of a charging plug connected to the charging cable, is maintained accordingly.

Naturally, two or more cooling lines can also be arranged within the charging cable, all of which are arranged within the cable sheath.

As a coolant fluid, for example, water can be employed. Ketone, specifically fluorinated ketone, can further be employed as a coolant fluid. Ketone has an advantage, in that it is not electrically conductive.

Preferably, the charging cable is configured such that a cavity in the charging cable between the cable sheath and the cooling line is filled with the heat conduction medium, such that the heat conduction medium is in direct contact with the cooling line.

A further improvement in thermal conduction within the charging cable is achieved as a result, such that the temperature of the charging cable and of the electric conductor cable/electric conductor cables is further reduced, such that higher charging currents can be transmitted by means of the charging cable.

Preferably, the charging cable comprises at least one heat conduction cord, which is in direct contact with the heat conduction medium.

As a result of the presence of the heat conduction cord, the charging cable comprises fewer cavities/voids which are filled with the heat conduction medium. As the heat conduction cord can show a high thermal conductivity, specifically if the heat conduction cord, for example, is constituted of copper, the evacuation of heat generated in the electric conductor cable to the remainder of the charging cable is further improved, such that higher charging currents can be transmitted by means of the charging cable, with no inordinate heat-up of the latter.

Preferably, the charging cable comprises at least one filler cord, which is impregnated with the heat conduction medium.

The function of the filler cord is the storage of the heat conduction medium. Specifically, this provides advantages during the manufacture of the charging cable as, prior to stranding, the filler cord is impregnated with the heat conduction medium, for example by drawing the filler cord through a bath which is saturated with the heat conduction medium, prior to stranding. During stranding, the filler cord is compressed, such that the heat conduction medium contained in the filler cord is discharged into the cavities within the charging cable.

As a filler cord, for example, a fibrous fabric/fibrous cord, specifically formed of a cotton fabric, can be employed.

Preferably, the charging cable comprises a metal cladding which encloses the cable sheath.

The metal cladding further enhances the thermal evacuation of heat generated by the electric conductor cable to the environment of the charging cable. Heat generated in the electric conductor cable can thus be evacuated from the charging cable even more effectively, thereby reducing the temperature of the charging cable. A correspondingly configured charging cable thus permits the transmission of higher charging currents, with no associated overheating of the charging cable, and specifically of the electric conductor cable.

As a material for the metal cladding, steel, copper, brass, aluminum or alloys of these metals can be employed.

Preferably, the charging cable is configured such that the heat conduction medium is configured as a gel, specifically as a gel which is loaded with a ceramic powder.

Preferably, the charging cable is configured such that the heat conduction medium is configured as a dispersion, specifically as a dispersion which is loaded with a ceramic powder.

Aluminum nitride, silicon carbide, aluminum oxide etc. can be employed as ceramic powders.

The object of the present invention is further fulfilled by a charging plug for connection to a corresponding connecting device and for the transmission of electrical energy, wherein the charging plug comprises at least one power contact which is arranged in a charging plug housing, wherein a second contact region of the power contact is galvanically connected to a charging cable according to one of the preceding claims, and wherein a first contact region of the power contact is accessible via a contact side of the charging plug housing.

The object of the present invention is further fulfilled by a charging station for discharging electrical energy to a recipient of electrical energy, which comprises a charging plug of the above-mentioned type.

Further advantages, details and characteristics of the invention proceed from the exemplary embodiments described hereinafter. Specifically:

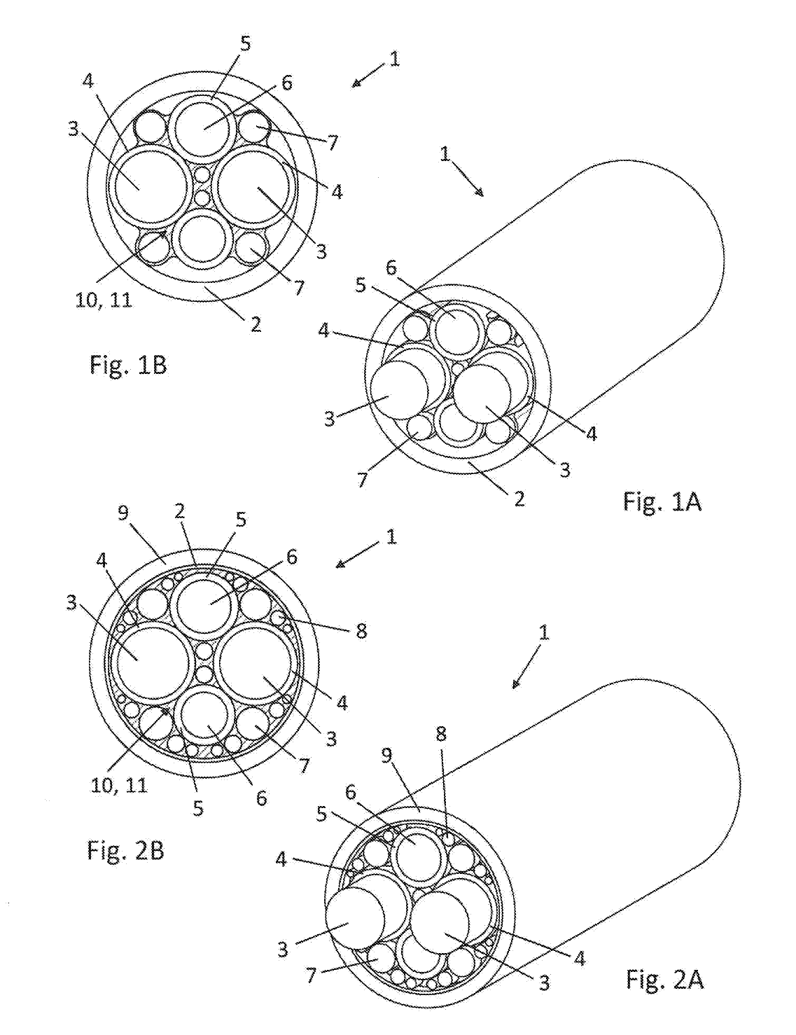

FIG. 1A: shows a perspective representation of a charging cable according to the invention, according to a first form of embodiment of the present invention;

FIG. 1B: shows a cross-sectional representation of the charging cable represented in FIG. 1A;

FIG. 2A: shows a perspective representation of a charging cable according to the invention, according to a second form of embodiment of the present invention; and

FIG. 2B: shows a cross-sectional representation of the charging cable represented in FIG. 1A.

In the following description, identical components or identical characteristics are identified by identical reference numbers, such that the description of a component provided with reference to one figure is also valid for the remaining figures, thereby obviating any repeated description. Moreover, individual characteristics described with reference to one form of embodiment can also be applied separately in other forms of embodiment.

FIGS. 1A and 1B represent a charging cable 1 according to a first form of embodiment of the present invention wherein, in FIG. 1A, the charging cable 1 is shown in a perspective representation and, in FIG. 1B, is shown in a cross-sectional representation.

The charging cable 1 for the transmission of electrical energy comprises a cable sheath 2, which encloses all the components of the charging cable 1. The charging cable 1 further comprises two electric conductor cables 3 which, in the exemplary embodiment represented, are configured for the transmission of direct current. The two electric conductor cables 3 are respectively enclosed in an insulating sheath 4, such that the electric conductor cables 3 are not in electrical contact with their environment.

From FIGS. 1A and 1B it can be seen that, within the charging cable 1, cavities 10 are arranged between the cable sheath 2 and the electric conductor cable 3, more specifically between the cable sheath 2 and the insulating sheaths 4. These cavities 10 are filled with a heat conduction medium 11, such that the heat conduction medium 11 is in direct contact with the insulating sheaths 4 of the electric conductor cables 3.

Consequently, heat generated within the electric conductor cables 3 by ohmic losses is evacuated, in a highly effective manner, to the heat conduction medium 11, which then discharges the heat thus taken up to the remaining structures and components of the charging cable 1. Any overheating of the electric conductor cables 3 is thus effectively counteracted by the provision of the heat conduction medium 11 in the cavities 10 of the charging cable 1.

From FIGS. 1A and 1B, it can be seen that the charging cable 1 further comprises two cooling lines 5, in each of which a coolant fluid duct 6 is configured. The cooling lines 5 are arranged to accommodate a flux of a coolant fluid. Heat generated by the electric conductor cables 3 and transmitted to the heat conduction fluid 10 is thus effectively evacuated by means of a coolant fluid stream within the cooling lines 5, which are also in direct contact with the heat conduction medium 11.

It can further be seen that the charging cable 1 comprises a plurality of heat conduction cords 7, which are likewise in direct contact with the heat conduction medium 11. The heat conduction cords 7 can be configured, for example, in the form of copper lines 7. The heat conduction cords 7 have a high thermal conductivity, such that heat taken up by the heat conduction fluid 11 is effectively distributed within the charging cable 1 by means of the heat conduction cords 7.

The charging cable 1 according to the invention further comprises a plurality of filler cords 8, which are likewise in direct contact with the heat conduction medium 11. The filler cords 8 can be configured of a fibrous material, for example of a cotton fiber fabric. During the manufacture of the charging cable 1, the filler cords 8 can be impregnated with the heat conduction medium 11 such that, upon stranding of the charging cable 1, the heat conduction medium 11 stored in the filler cords 8 is discharged into the cavities 10 in the charging cable 11.

FIGS. 2A and 2B represent a charging cable 1 according to a second form of embodiment of the present invention wherein, in FIG. 2A, the charging cable 1 is shown in a perspective representation and, in FIG. 2B, is shown in a cross-sectional representation. The charging cable 1 according to the second form of embodiment differs from the charging cable 1 according to the first form of embodiment, in that the charging cable 1 according to the second form of embodiment further comprises a metal cladding 9, which encloses the cable sheath 2 of the charging cable 1. The metal cladding 9 enhances the evacuation of heat from the charging cable 1 to the environment. The remaining design of the charging cable 1 according to the second form of embodiment is identical to the configuration of the charging cable 1 according to the first form of embodiment, such that reference may be made to the above description accordingly.

### LIST OF REFERENCE NUMBERS

1 Charging cable
2 Cable sheath
3 Electric conductor cable
4 Insulating sheath (of the electric conductor cable)
5 Cooling line
6 Coolant fluid duct (of the cooling line)
7 Heat conduction cord/copper cord
8 Filler cord
9 Metal cladding
10 Cavity in the charging cable
11 Heat conduction medium/heat conduction gel/heat conduction fluid

1. A charging cable (1) for transmitting electrical energy, having a cable sheath (2) and at least one electric conductor cable (3) arranged within the cable sheath (2), characterized in that at least one cavity (10) within the charging cable (1), between the cable sheath (2) and the electric conductor cable (3), is filled with a heat conduction medium (11) such that the heat conduction medium (11) is in direct contact with the electric conductor cable (3).

2. The charging cable (1) as claimed in claim 1, characterized in that the charging cable (1) comprises at least one cooling line (5), which is arranged within the cable sheath (2) and can accommodate a flux of coolant fluid.

3. The charging cable (1) as claimed in claim 2, characterized in that a cavity (10) in the charging cable (1), between the cable sheath (2) and the cooling line (5) is filled with the heat conduction medium (11), such that the heat conduction medium (11) is in direct contact with the cooling line (5).

4. The charging cable (1) as claimed in one of the preceding claims, characterized in that the charging cable (1) comprises at least one heat conduction cord (7), which is in direct contact with the heat conduction medium (11).

5. The charging cable (1) as claimed in one of the preceding claims, characterized in that the charging cable (1) comprises at least one filler cord (8), which is impregnated with the heat conduction medium (11).

6. The charging cable (1) as claimed in one of the preceding claims, characterized in that the charging cable (1) comprises a metal cladding (9) which encloses the cable sheath (2).

7. The charging cable (1) as claimed in one of the preceding claims, characterized in that the heat conduction medium (11) is configured as a gel (11), specifically as a gel (11) which is loaded with a ceramic powder.

8. The charging cable (1) as claimed in one of claims 1 to 6, characterized in that the heat conduction medium (11) is configured as a dispersion (11), specifically as a dispersion (11) which is loaded with a ceramic powder.

9. A charging plug for connection to a corresponding coupling device and for the transmission of electrical energy, characterized in that the charging plug comprises at least one power contact, which is arranged in a charging plug housing, wherein a second contact region of the power contact is galvanically connected to a charging cable (1) as claimed in one of the preceding claims, and wherein a first contact region of the power contact is accessible via a contact side of the charging plug housing.

10. A charging station for discharging electrical energy to a recipient of electrical energy, characterized in that the charging station comprises a charging plug as claimed in claim 9.
